(19) United States
(12) Patent Application Publication
(10) Pub. No.: US 2016/0230439 A1
(43) Pub. Date: Aug. 11, 2016

(54) System and Method for Securing a Garage Door

(71) Applicant: Alex Wolfram, Scottsdale, AZ (US)

(72) Inventor: Alex Wolfram, Scottsdale, AZ (US)

(21) Appl. No.: 15/018,847

(22) Filed: Feb. 8, 2016

Related U.S. Application Data
(60) Provisional application No. 62/113,164, filed on Feb. 6, 2015.

(51) Int. Cl. E05F 5/00; E05D 13/00

(52) U.S. Cl. CPC E05F 5/003; E05D 13/00

(57) ABSTRACT

A garage defense system is disclosed. The system can comprise a main plate, a brace, a thumb screw and a pair of fasteners. The main plate can comprise a slot and one or more pairs of first fastener orifices. The brace can comprise an indention and a pair of brace arms on opposite sides of the indention. Further, the indention can wrap around a connection arm, and can comprise a thumb screw orifice. Each of the brace arms can comprise a second fastener orifice. The second fastener orifices on the brace arms can be aligned with the first fastener orifices. Each fastener can pass within one of the first fastener orifices and the second fastener orifices, such that the brace is connected to the main plate.

This application claims priority to provisional application 62/113,164 filed Feb. 6, 2015, entitled “Garage Defender.”

### BACKGROUND

This disclosure relates to a system and method for securing a garage door.

Garage break-ins are a growing problem today. One of the reasons that garage-break-ins are increasing is because breaking into a typical garage is actually quite simple and fast. A garage door can be broken into in just 6 seconds. A burglar can easily slip a thin wire through the small gap between the frame and the top edge of the garage door. The wire can be bent to resemble the shape of a hook, which can be used to pull on the emergency release mechanism or drop down rope. After pulling the emergency release mechanism or the drop down rope, the garage door can be opened. A garage break-in may take an even shorter amount of time if the garage door has windows wherein the release mechanism or drop down rope can be visible. Some solutions exist, however, such solutions to this problem requires a permanent and complicated installation process.

As such it would be useful to have an improved system and method for securing a garage door.

### SUMMARY

A garage defense system is disclosed. The system can comprise a main plate, a brace, a thumb screw and a pair of fasteners. The main plate can comprise a slot and one or more pairs of first fastener orifices. The brace can comprise an indention and a pair of brace arms on opposite sides of the indention. Further, the indention can wrap around a connection arm, and can comprise a thumb screw orifice. Each of the brace arms can comprise a second fastener orifice. The second fastener orifices on the brace arms can be aligned with the first fastener orifices. Each fastener can pass within one of the first fastener orifices and the second fastener orifices, such that the brace is connected to the main plate.

### BRIEF DESCRIPTION OF THE DRAWINGS

FIG. 1 illustrates a garage defense system installed in a garage door system.

FIG. 2 illustrates a main plate comprising one or more pair of fastener orifice, and a slot.

FIG. 3 illustrates a brace comprising a pair of brace arms and an indention capable of wrapping around a connection arm.

FIG. 4A illustrates a thumb screw.

FIG. 4B illustrates a clip comprising a nut.

FIG. 5 illustrates an embodiment of a plate.

FIG. 6 illustrates an embodiment of fasteners.

FIG. 7A illustrates positioning of a main plate with the joint of a connection arm

FIG. 7B illustrates fastening main plate with a brace through fasteners.

FIG. 7C illustrates tightening a brace with a connection arm using a thumb screw.

### DETAILED DESCRIPTION

Described herein is a system and method for securing a garage door. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Similarly, any dimensions given are solely exemplary, i.e., offered to give a person having ordinary skill in the art an example implementation, and are not limiting. Accordingly, the claims appended hereto are not intended to be limited by the disclosed embodiments, but are to be accorded their widest scope consistent with the principles and features disclosed herein.

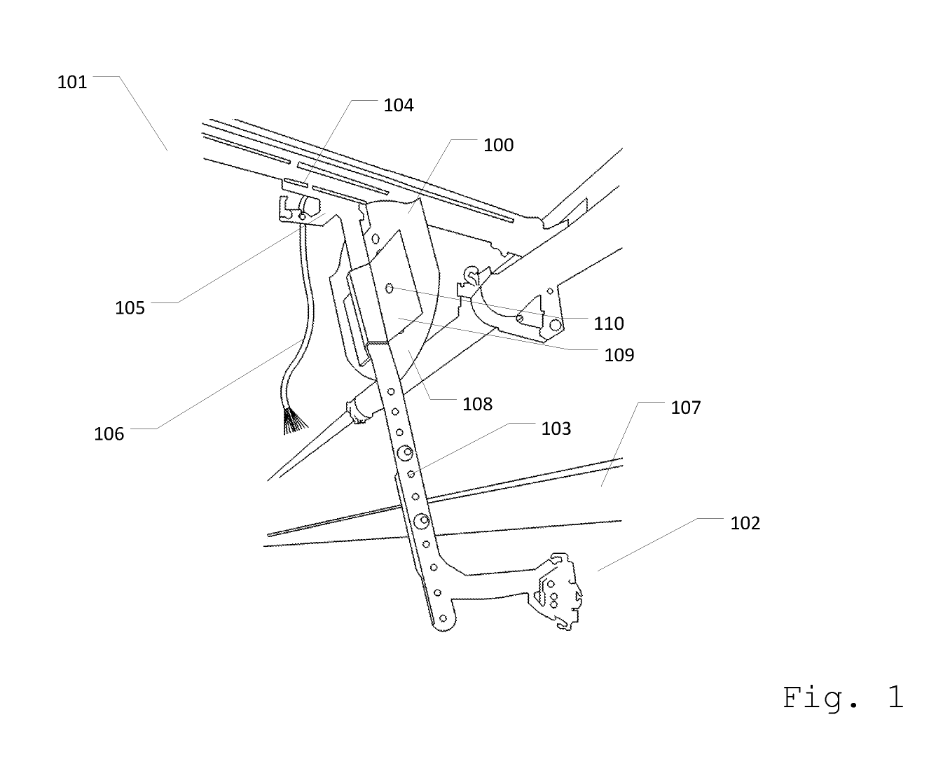

FIG. 1 illustrates a garage defense system 100 installed in a garage door system 101. Garage door system 101 that is installed to a garage door 102 can mainly comprise of a connection arm 103, and a pulley 104. Connection arm 103 can be a support frame used to connect garage door 102 with pulley 104. Moreover, connection arm 103 can be referred to as the J-arm, curved arm, L-link, door brace, door arm, and so on. Pulley 104 can be used pull connection arm 103 to lift garage door 102. Pulley 104 can further comprise a release mechanism 105 and a release rope 106. Pulling release mechanism 105 using release

rope 106 can allow garage door 102 to open. Garage defense system 100 can be installed and/or mounted to connection arm 103 of garage door system 101. Moreover, garage defense system 100 can prevent release mechanism 105 and release rope 106 from being accessed through a gap 107 of garage door 102. Gap 107 can be a small opening above garage door 102.

Further, garage defense system 100 can comprise a main plate 108, a brace 109, and one or more fasteners 110. In one embodiment, garage defense system 100 can comprise of plastic materials. In some embodiment, garage defense system 100 can comprise of metal materials such as aluminum. Main plate 108 can be a thin platform that is used as a barrier between pulley 104 and gap 107. Brace 109 can be capable of securing main plate 108 with connection arm 103. Fasteners 110 can be any type of fastening mechanism, which can include but is not limited to clamp, screws, nuts, and bolts. Fasteners 110 can affix main plate 108 to connection arm 103. In a preferred embodiment, fasteners 110 can be a quick release fastener such as a snap-in fastener that can secure main plate 108 with brace 109 and connection arm 103.

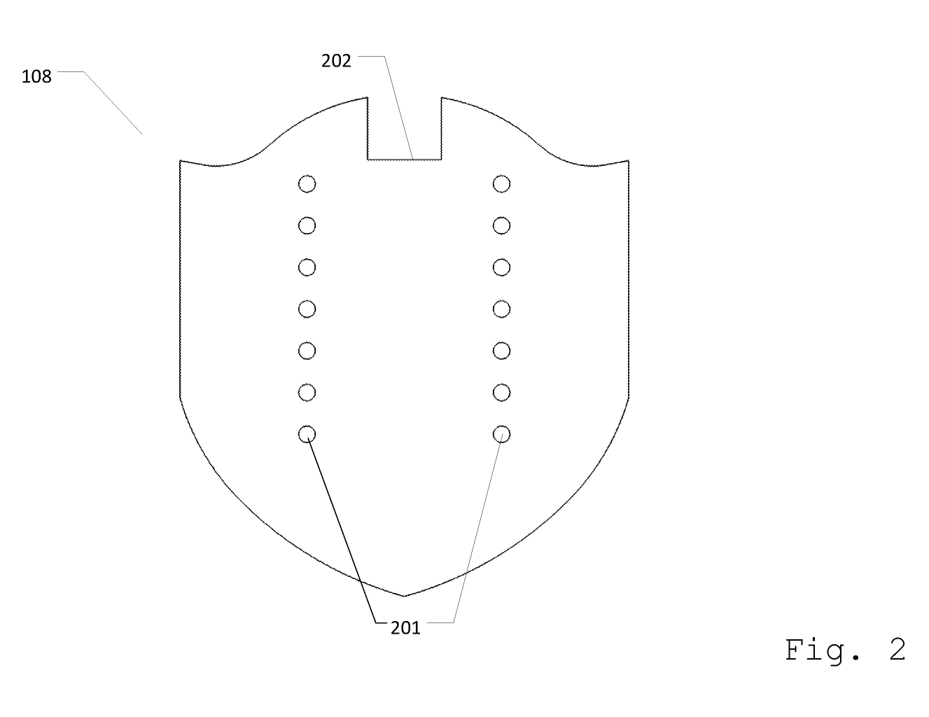

FIG. 2 illustrates a main plate 108 comprising one or more pairs of fastener orifice 201, and a slot 202. Main plate 108 can be in any shape and size, such as substantially rectangular, and circular. Main plate can prevent an intruder from using a wire to engage release mechanism 105.

In this embodiment, each fastener orifice 201 can be a circular shape orifice from the front face through the back face of main plate 108. Pairs of fastener orifice 201 can be aligned vertically along the middle section of main plate 108. Each pair of fastener orifice 201 can be at a certain distance to the left and right of the center of main plate 108, such that fastener orifice 201 can be aligned with brace 109. Moreover, pair of fastener orifice 201 can be equidistant from the side faces of main plate 108. Furthermore, fastener orifice 201 can allow main plate 108 to be adjusted for optimal fit, adjacent and flush to garage door pulley 104.

In this embodiment, the top and wider portion of main plate 108 can be the top face of main plate 108, which can comprise slot 202. Slot 202 can be an orifice through the center of the top face of main plate 108. Slot 202 can be used to create a passage for the joint of connection arm 103. Additionally, slot 202 can ensure that garage door pulley 104 can move with ease and not encounter garage defense system 100 when garage door system 101 expands and retracts during the opening and closing of garage door 102. In a preferred embodiment, slot 202 can comprise a substantially rectangular or square shape. Example dimensions of slot 202 can be 1 inch by 1 inch. In some embodiments, slot 202 can comprise varying vertical cross-sectional shapes and sizes that can allow enough space for the movement of the joint of connection arm 103 but still protects release mechanism 105 and release rope 106 from being engaged by any wire that is used by an individual to break into the garage.

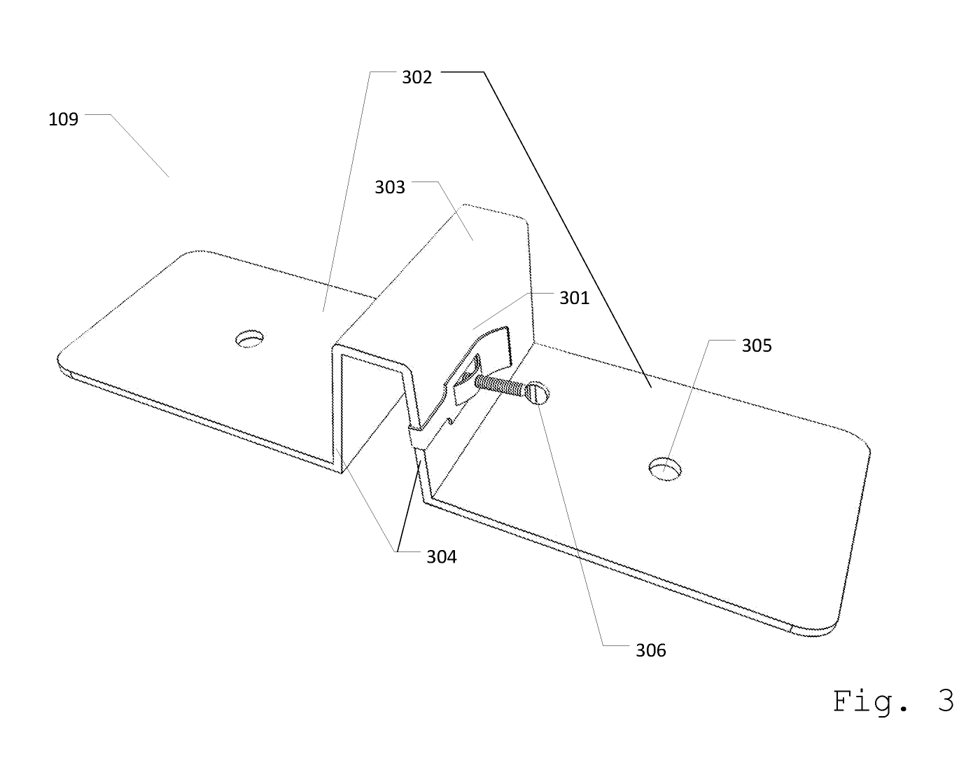

FIG. 3 illustrates brace 109 comprising an indention 301, and a pair of brace arms 302. Brace 109 can be a frame, which surrounds connection arm 103 of garage door 102, and provides a platform for main plate 108 to attach to. Indention 301 can wrap around the back face and the side faces of connection arm 103 of garage system 101. Indention 301 can be a U-shaped plate that can comprise a back plate 303 and a pair of side plates 304. Back plate 303 can be perpendicular to side plates 304, which protrude forwards from the side faces of back plate 303. Back plate 303 can comprise a width that is compatible with the back face of connection arm 103. When indention 301 is engaged with connection arm 103, back plate 303 can be adjacent to the back face of connection arm 103. In a preferred embodiment, indention 301 can comprise a width of 0.515 inches and a height of 4 inches. Side plates 304 can be an angle away from each other, and protrude forwards from the side faces of back plate 303. Side plates 303 can comprise a width that corresponds to the height of the side faces of connection arm 103. In a preferred embodiment, each side plate 304 can comprise a width of 0.15 inches, a height of 4 inches, and a depth of 1 inch.

In a preferred embodiment, brace 109 can comprise side plates 304 that have a distance of 0.60 inches in between the inner front edges of side plates 304. Each brace arm 302 can extend outwards from the inner front edges of side plates 304. Brace arms 302 can be perpendicular to side plates 304 and parallel to back plate 303. In a preferred embodiment, brace arms 302 can comprise a width of about 3 inches, a height of 4 inches, and a depth of 0.125 inches. Each brace arm 302 can comprise a hole 305. Hole 305 can be a circular orifice through the back and the front faces of brace arms 302. Hole 305 can house fasteners 110, when fasteners 110 are engaged. Hole 305 can be a certain distance away from the inner edge of brace arms 302, which correspond to fastener orifice 201. In a preferred embodiment, each brace arm 302 can comprise hole 305 that is roughly 1⅓ inches from the inner edge of each brace arms 302, and 2 inches from the bottom edge of each brace arm 302. Additionally, hole 305 can have a radius of around 0.29 inches in one embodiment. Such measurements are based on common dimensions of presently regularly manufactured garage doors, but can be adjusted by a person having ordinary skill in the art to perform substantially the same method as described in this disclosure on garage doors having different dimensions.

In some embodiments, each brace arm 302 can comprise hole 305 of varying size and locations, so long as hole 305 can correspond with fastener orifice 201.

In one embodiment, brace 109 can further comprise a thumb screw 306 and a clip 307. In a preferred embodiment, thumb screw 306 can be permanently attached to side plate 304 through a clip 307. Clip 307 can be attached to one of side plates 304. Clip 307 can be placed at the bottom of one of side plate 304, and near the junction of one of side plate 304 and one of brace arm 302. Further, thumb screw 306 can be attached at the top portion of clip 307.

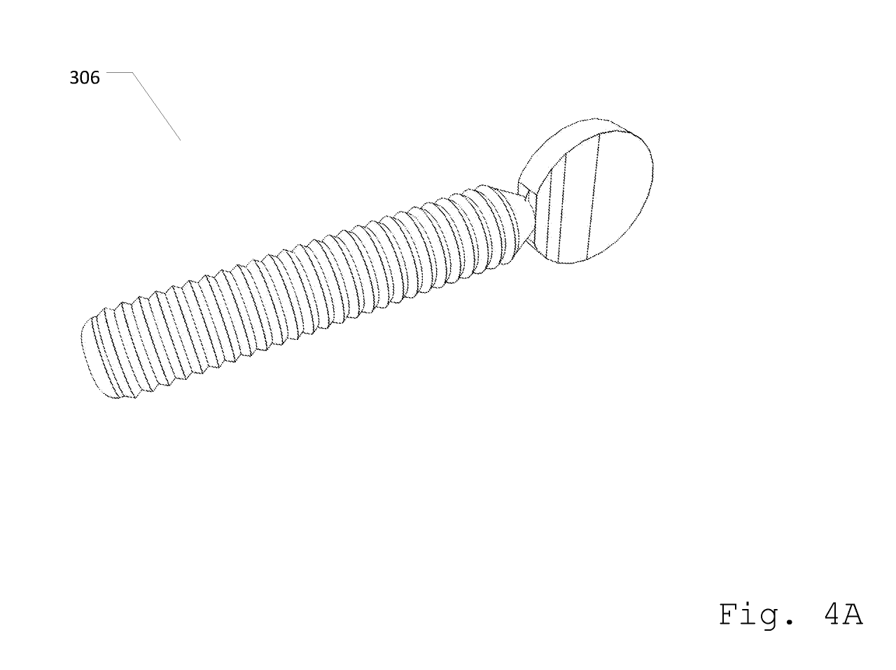

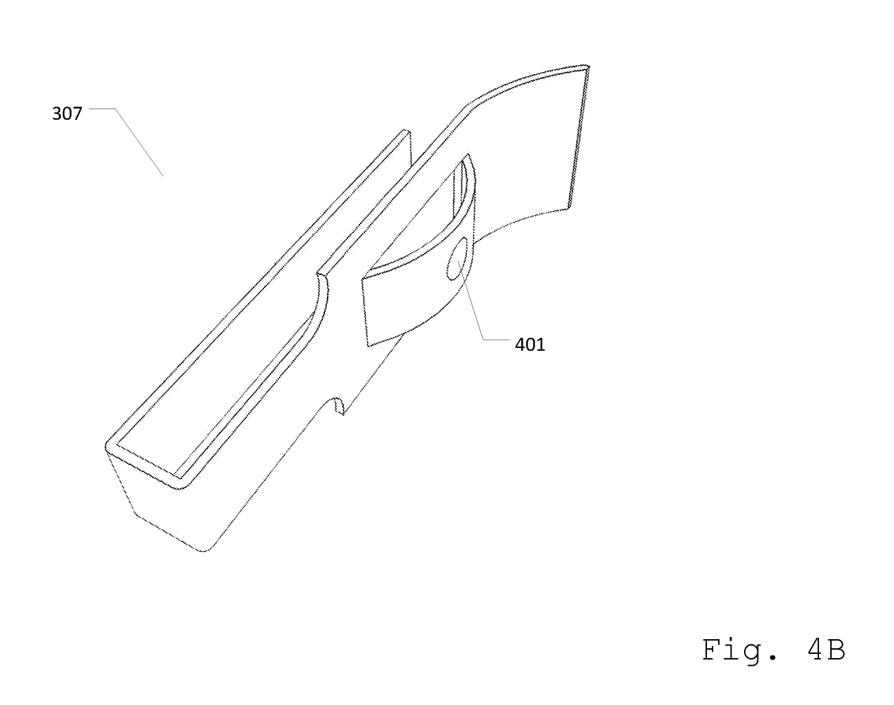

FIG. 4A illustrates thumb screw 306. Thumb screw 306 can comprise a flat vertical heat that can allow the user to easily turn and actuate thumb screw 306. Furthermore, thumbscrew 306 can comprise a flat tip such that when thumb screw 306 is driven towards connection arms 103, the flat tip of thumbscrew 306 can provide better hold with connection arms 103.

FIG. 4B illustrates clip 307 comprising a nut 401. In one embodiment, clip 307 can be attachable and detachable from brace 109. In such embodiment, the flexible prongs of clip 307 can wrap around brace 109, which secures clip 307 in place. In another embodiment, clip 307 can be permanently attached to brace 109 through methods that include but are not limited to fastening, molding, cementing, and soldering. Further, thumb screw 306 can be compatible and mateable with clip 307. As such, the shaft of thumb screw 306 can be insertable within nut 401 of clip 307 in such a way that fastens the two together when thumb screw 306 screws into clip 307.

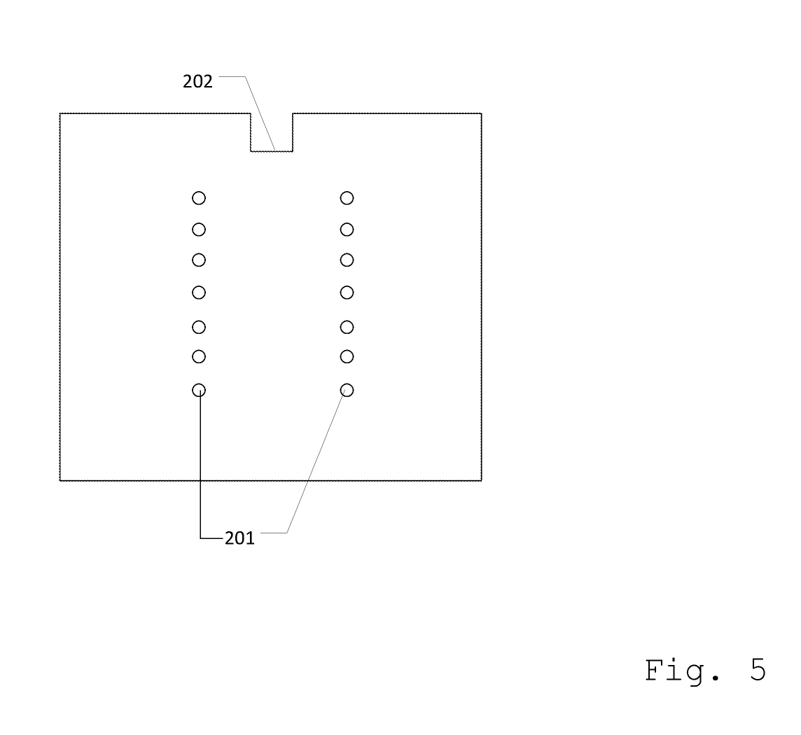

FIG. 5 illustrates an embodiment of main plate 108. In this embodiment, main plate 108 can be substantially rectangular shape. In a preferred substantially rectangular shape embodiment, main plate 108 can comprise a height of 9 inches, a width of 10 inches, and a depth of 0.125 inches or more

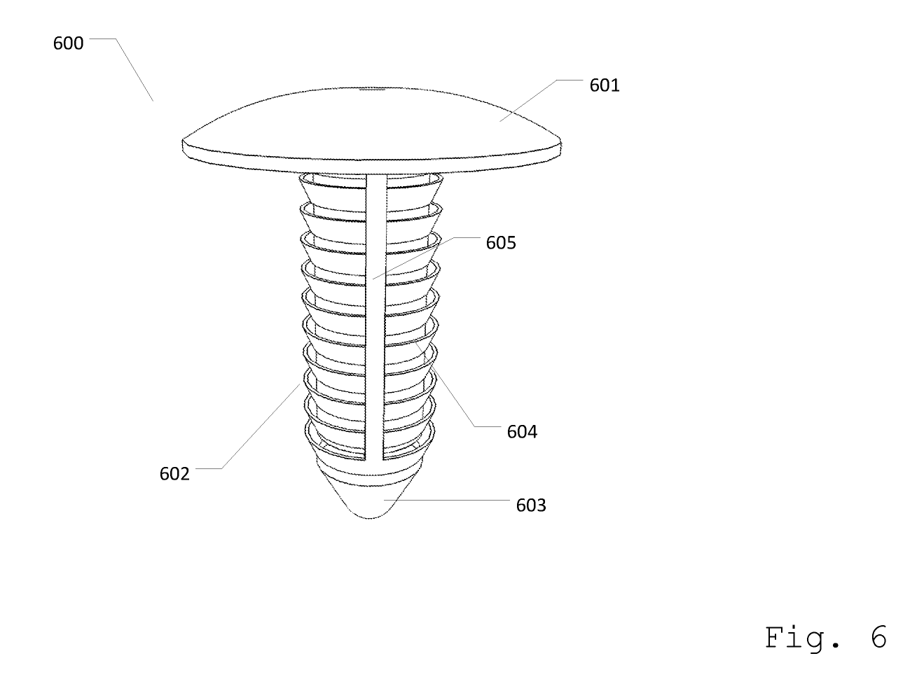

FIG. 6 illustrates an embodiment of fasteners 110. In this embodiment, garage defense system 100 can be capable of quick attachment onto connection arm 103. In such embodiment, fasteners 110 can be any quick attachment fasteners that can include but are not limited to quick release pin, snap-in fastener, or a panel retainer 600. Panel retainer 600 can comprise a head 601, a body 602, and a tip 603. Head 601 can form at the top of panel retainer 600. Head 601 can be capable of preventing panel retainer 600 from slipping out of fastener orifice 201. In one embodiment, body 602 can have angled ridges 604 and a non-ridged portion 605. Non-ridged portion 605 can be a flat vertical portion along body 602 that runs perpendicular with head 601. Tip 603 can be a pointed tip of panel retainer 600. Angled ridges can allow panel retainer to slip into fastener orifice 201 and holes 305 with little resistance, but come back out with great resistance.

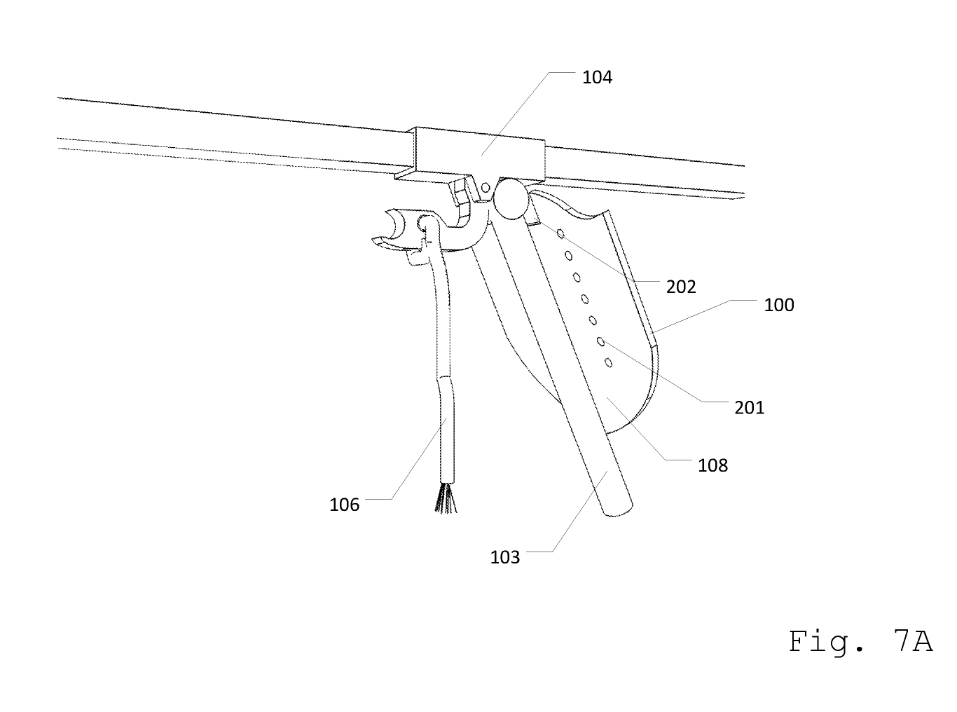

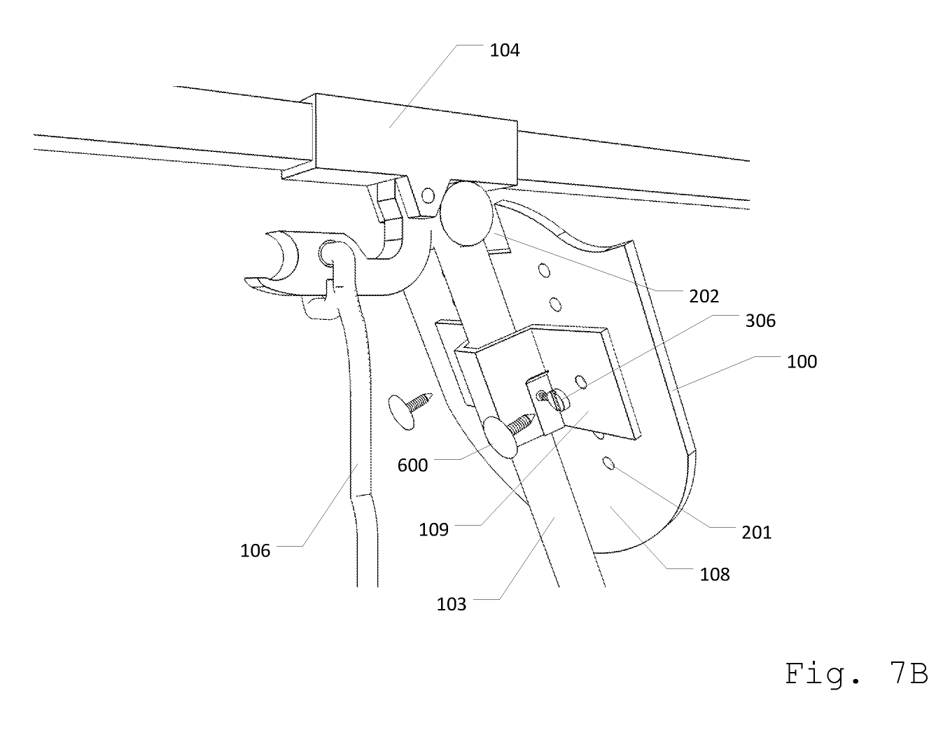

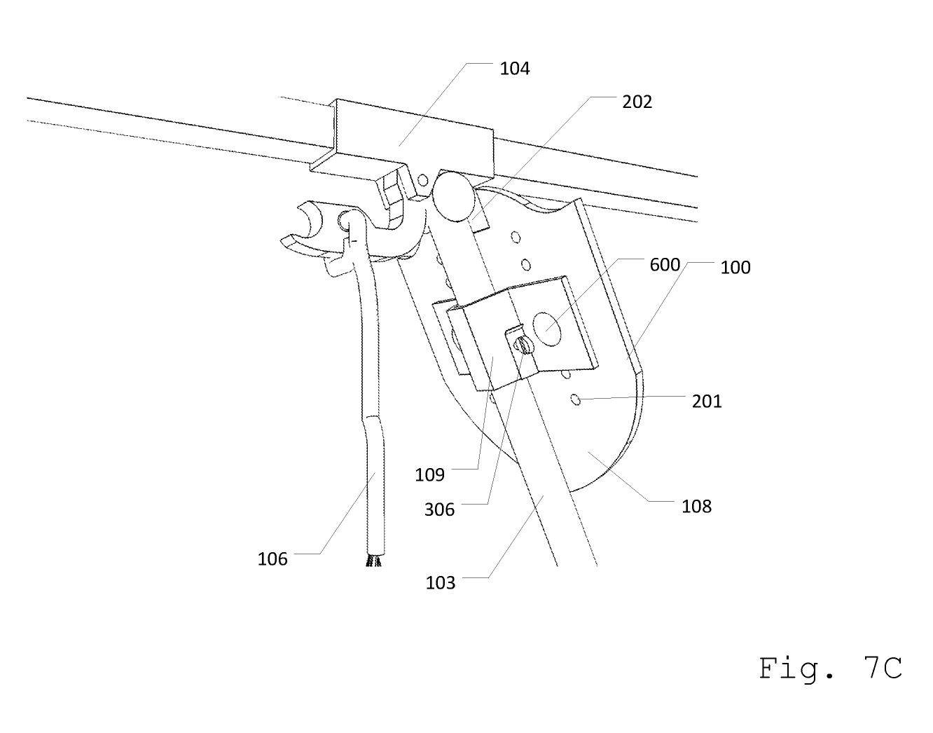

FIG. 7A illustrates positioning of main plate 108 with the joint of connection arm 103. Initially, the back face of main plate 108 can be positionable against the front face of connection arm 103. Furthermore, slot 202 can be aligned as close as possible with the joint of connection arm 103, towards pulley 104. Main plate 108 can be positionable on connection arm 103 such that main plate 108 does not disrupt the movement of connection arm 103, when garage door 102 opens and closes.

Next, brace 109 can be aligned against the back face of connection arm 103 and the back face of main plate 108. The front face of back plate 303 can be positionable against the bottom face of connection arm 103, while the front face of brace arms 302 can be adjacent to the back face of main plate 108. The vertical position of brace 109 can be adjusted in relation to fastener orifice 201 of main plate 108 through sliding brace 109 within connection arm 103.

FIG. 7B illustrates fastening main plate 108 with brace 109 through fasteners 110. Brace 109 can be adjusted and be aligned such that holes 305 can be aligned with one of the pairs of fastener orifice 201. Once aligned, a pair of panel retainers 600 can be pushed through holes 305 and fastener orifice 201. Inserting panel retainers 600 through holes 305 and fastener orifice 201 can secure main plate 108 to connection arm 103. Brace 109 must be adjacent to main plate 108 throughout the process until garage defense system 100 is secured with panel retainers 600.

FIG. 7C illustrates tightening brace 109 with connection arm 103 using thumb screw 306. After panel retainers 600 are attached to garage defense system 100, thumb screw 306 that is mounted onto brace 109 can be fastened to secure brace 109 with connection arm 103. Once garage defense system 100 is securely attached to connection arm 103, main plate 108 can serve as a barrier when an individual tries to reach release mechanism 105 or release rope 106, through gap 107 on garage door 102.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A garage defense system comprising
a main plate comprising a slot and one or more pairs of first fastener orifices;
a brace comprising an indention and a pair of brace arms on opposite sides of said indention, further said indention capable of wrapping around said connection arm, said indention further comprising a thumb screw orifice, wherein each of said brace arms comprise a second fastener orifice, each of said second fastener orifices on said brace arms alignable with one of said first fastener orifices and
a thumb screw passing through said thumb screw orifice, said thumb screw affixing said brace to said connection arm; and
a pair of fasteners insertable within one of said first fastener orifices and said second fastener orifices, such that said brace is connected to said main plate.

2. The brace of the garage defense system of claim 1 further comprising a clip with a nut connected to either side of said indention.

3. The brace of the garage defense system of claim 1 wherein said clip with said nut is detachable.

4. The brace of the garage defense system of claim 1 wherein said clip with said nut is permanently attached.

5. The system of claim 1 wherein said fasteners comprise snap-in fasteners.

6. The system of claim 6 wherein said snap-in fastener is a panel retainer comprising ridges that allow said panel retainer to push into said first and second orifices with little resistance, but come out of said first and second orifices with great resistance.

7. The garage defense system of claim 1 wherein each of said pairs of fastener orifices are circular shape orifices from the front face through the back face of said main plate.

8. The garage defense system of claim 1 wherein said main plate is substantially rectangular in shape.

9. The garage defense system of claim 1 wherein said main plate comprises plastic materials.

10. The garage defense system of claim 1 wherein said main plate comprises aluminum materials.

11. A method of securing a garage door comprising of steps
mounting a garage defense system to a connection arm of a garage door system, wherein said garage defense system comprises
a main plate comprising of a slot and one or more pairs of first fastener orifice, said slot positionable to a connection arm of a garage door system;
a brace comprising an indention and a pair of brace arms, said indention capable of wrapping around said connection arm, wherein each of said brace arms comprises a second fastener orifices, said second fastener orifices on said brace arms aligns on said pairs of first fastener orifice; and
a pair of fasteners insertable within one of said pairs of first fastener orifices, and said second fastener orifices; and
fastening said main plate and said brace with said connection arm through said fasteners.

12. The method of claim 11 further comprising the step of adjusting the position of said brace against the back face of said connection arm and the back face of said main plate such that said hole on said brace arms are aligned with one of said pairs of first fastener orifices, wherein said brace comprising a thumbscrew.

13. The method of claim 11 further comprising the steps of inserting said first fasteners orifices through said hole and said second fastener orifices,

14. The method of claim 11 further comprising the steps of tightening said thumbscrew against connection arm of said garage door system.

15. The method of claim 11 prior to mounting said garage defense system further comprising the step of positioning said main plate against the front face of said connection arm, such that said slot is aligned as close as possible with the joint of said connection arm.

16. The method of claim 11 wherein said fasteners comprise snap-in fasteners.

17. The method of claim 16 wherein said snap-in fastener is a panel retainer comprising ridges that allow said panel retainer to push into said first and second orifices with little resistance, but come out of said first and second orifices with great resistance.

18. The method of claim 11 wherein said main plate is substantially rectangular in shape.
